(19) United States
(12) Patent Application Publication
(10) Pub. No.: US 2014/0055211 A1
(43) Pub. Date: Feb. 27, 2014

(54) LINEAR STRIPLINE PHASE SHIFTER

(71) Applicant: Juan Segador Alvarez, Arganda del rey (Madrid) (ES)

(72) Inventor: Juan Segador Alvarez, Arganda del rey (Madrid) (ES)

(21) Appl. No.: 13/582,766

(22) PCT Filed: May 9, 2011
(86) PCT No.: PCT/ES11/70332

§ 371 Date: Sep. 5, 2012

(51) Int. Cl. H01P 1/18

(52) U.S. Cl. CPC H01P 1/184
USPC 333/161

(57) ABSTRACT

Linear stripline phase shifter which has a base (13) and a cover (20) that form a closed assembly and the phase shifter has inputs (A1) and (A2) and outputs (B), (C), (F) and (E), having in the interior of the assembly formed by the base and cover two fixed circuits (1) and a mobile circuit (9) which is displaced linearly, and where both circuits are formed by sections of stripline line, where the connection between the line sections of the fixed and mobile circuits is by capacitive coupling, and where the distance of the line sections of the fixed circuits to the ground plane formed by the base of the phase shifter is different. A greater bandwidth is achieved, a compact design and savings made in the number of welds to be carried out, and it is not necessary to use impedance transformers that limit bandwidth.

### OBJECT OF THE INVENTION

The object of this invention a linear stripline phase shifter, which uses the technology of stripline transmission lines and furthermore in which the movement produced in the phase shifter is linear.

Phase shifters try to achieve dynamic control by electromechanical means of the beam radiated by an antenna array.

An antenna array is formed by an assembly of N antennas, equal or not, which radiate or receive simultaneously. The radiation pattern of the assembly is obtained as the interference of the fields radiated by each of the antennas, while on reception the signal is a linear combination of the signals captured by each antenna.

Thanks to the phase shifters it is possible to obtain different pointing angles, feeding each of the antennas that make up the group with a high frequency electrical signal being differentiated in each of the antennas.

As a physical principle the electrical delay that is produced in the transmission lines is used to adjust the phase of the signal that arrives at each of the radiating elements in the array.

The present invention is characterised by the special configuration and design of the phase shifter, which is such that, by linking modules, it is possible to achieve a greater range of variation of the pointing angle of the group of radiating elements with respect to the state of the art, so modifications to the coverage area is achieved.

Another characteristic presented by the phase shifter object of the invention is the use of transmission lines known in this sector of the art as striplines. Some of these transmission lines are fixed and mobile lines slide along them in a linear motion the mobile lines achieving in this way variable phase and that all of them are connected to each other through capacitive coupling.

Another characterising aspect by the present phase shifter is the fact that the interconnection between the phase shift branches is performed internally, using cables with different impedances as terminations, resulting in greater compactness and minimising the number of necessary welds and interconnection circuits.

Therefore, the present invention is confined within the field of electromechanical means employed to achieve dynamic control of the beam radiated by an antenna array, and more particularly from between the phase shifters.

### BACKGROUND OF THE INVENTION

As previously noted the function of phase shifters is to control phase difference, using as a physical principle the electrical delay that is produced in the transmission lines to adjust the signal phase. The electrical delay can be achieved using several methods such as those set forth below.

One of them, as stated in patent JP5121902 A, published on 18 May 1993, consists of modifying the propagation speed of the transmission line, using for this the phase shifter with a piece of mobile dielectric material inserted between two conductors arranged coaxially.

Another method used to achieve electrical delay is disclosed in patent JP5121915 A, published on 28 May 1993 wherein the phase shifter disclosed has a mobile transmission line with respect to another fixed. The mobile line is connected to the power supply of the phase shifter and is coupled to the fixed line, so that when moving, the signal phase at one end of the fixed line varies with respect to the other end.

Another similar embodiment is disclosed in patent JP9246846 A published on 19 Sep. 1997. This invention discloses a phase shifter that includes three transmission line segments that are of a circular shaped stripline type and out of phase with each other in a perimetral direction, with a reception element being adjusted around a central point in contact with the corresponding line segment.

In European patent EP1208614 B1, published on 1 May 2004, an improved phase shifter is disclosed with respect to previous models and which has an input and four outputs, for connecting four radiating elements in two pairs. It has two segments of lines of strips (stripline in the common language of experts in antennas) arranged concentrically and a reception element common to the two segments located radially, this common reception element is able to rotate about a central axis that allows the relative differences between the signal phases at the ends of the stripline segments to be modified.

These disclosed systems have as a common characteristic the use of a circular movement of the phase shifter actuator, with the drawbacks that this entails.

Other linear driven phase shifters are known, which use coaxial cables, which necessarily involve complexity and difficulty in construction. Furthermore said phase shifters require the use of connection circuits with impedance transformers, which limit the bandwidth, increase the volume of the phase shifter and the number of welds needed. As a result of the construction characteristics of these phase shifters, the bandwidth they manage to cover is limited.

It is also known in the state of the art document WO 2007082419 wherein it is disclosed a differential phase continuously variable beam forming network, includes a metal cavity as well as the power divider group located in the metal cavity and several phasers,

Another phase shifter known is the one disclosed in JP2001237603 which discloses a miniaturized phase shifter having a movable mechanism, which is remote-controllable and can shift the phase accurately while reducing the number of settings.

The patent GB 2439761 A discloses a Phase shifting unit using mutually movable sections to vary path length while the patent US 2005184827 A, discloses a phasing element and variable depointing antenna including at least one such element

Now, and starting from this latter type of linear phase shifters made with coaxial cables, the attempt is made as a first aim to obtain phase shifters which increase the bandwidth they manage to cover, and furthermore where and if possible to simplify manufacture, reducing its complexity, the number of transformations and welds, developing for this purpose a phase shifter such as the one disclosed below and which is described in its essence in the first claim.

### DESCRIPTION OF THE INVENTION

The linear stripline phase shifter object of the invention, is a phase shifter produced with stripline transmission lines, and has a linear drive, and furthermore in which the interconnections between the upper and lower phase shift branches is carried out inside the phase shifter itself, using for this purpose cables with different impedances as terminations.

The phase shifter has a base or support which inside houses two fixed circuits arranged symmetrically with respect to a vertical axis, and has a linearly movable mobile circuit, which in its movement varies the relative phase of the individual outputs of the phase shifter assembly.

Both fixed circuits have an upper and lower branch, both straight, the upper branch in turn is composed of two straight line sections and the lower branch is also composed of two straight line sections, with both arms, the upper and lower joined at one of the ends of the central line sections of the fixed circuit, and the other end of the upper and lower branches are connected by capacitive coupling to the mobile circuit. The upper and lower branches at one of their ends are connected to the mobile circuit and at the another are joined together and to the terminations (coaxial cables) of the phase shifter.

The mobile circuit has four line sections in a “U” shape, where each “U” shaped assembly is connected by way of a capacitive coupling to one of the branches of one of the fixed circuits.

The mobile circuit has a slot that allows it to be moved linearly, with no imbalances, and furthermore also has a perforation, or any other means that allows connection with an external environment for operating the linear displacement.

In order to ensure that the branches of each one of the circuits has a different impedance by keeping a fixed width of the tracks or branches or line sections, the result achieved is that the distance to the ground plane varies, internally defining three different distances for each circuit fixed to the ground plane of the phase shifter.

The fixed circuits have a series of perforations, round or oblong which are arranged so that they coincide with a series of pins, round or oblong which are found on the base of the phase shifter, and in such a way that ensures the distance to the ground plane that give the branches or lines a certain impedance.

Due to the configuration of the phase shifter it is possible to link several blocks and increase the number of outputs.

Therefore, with the construction characteristics laid out which are presented by the phase shifter object of the invention, the advantages derived from this particular design are the following:

A greater bandwidth is achieved than those achieved with phase shifters, which although linear employ a coaxial coupling, and require connection circuits with impedance transformers.

As a result of having the connections between the phase shift branches inside the phase shifter a compact design is achieved and savings made in the number of welds to be carried out.

Furthermore, due to the use of cables with different impedances as termination it is not necessary to use transformers which change the impedance and limit the bandwidth.

You can expand the number of outputs by using several blocks linked together.

### EXPLANATION OF THE DRAWINGS

To complete the description set forth below and with the object of assisting in a better understanding of the characteristics of the present invention, accompanying said description as an integral part thereof, is a set of drawings wherein, by way of illustration and not restrictively, the most significant details of the invention are represented.

FIG. 1 shows a plan view of the interior of a phase shifter and particularly the two fixed circuits and the mobile circuit, in addition to the inputs and outputs of the phase shifter.

FIG. 2 shows the representation of the fixed circuit.

FIG. 3, shows the representation of the mobile circuit.

FIG. 4, shows the base of the phase shifter.

FIG. 5, shows the interior of the phase shifter.

FIG. 6, shows the closed phase shifter.

FIG. 7, shows the power supply diagram of an antenna array of various elements.

FIG. 8, shows a representation of what would be entailed with connections outside of the phase shifter, and having lines with the same impedance.

FIG. 9, shows the linked interconnection with other phase shifters to expand the number of outputs.

### PREFERRED EMBODIMENT OF THE INVENTION

In view of the aforementioned figures disclosed below is a preferred embodiment of the invention and the explanation of the drawings.

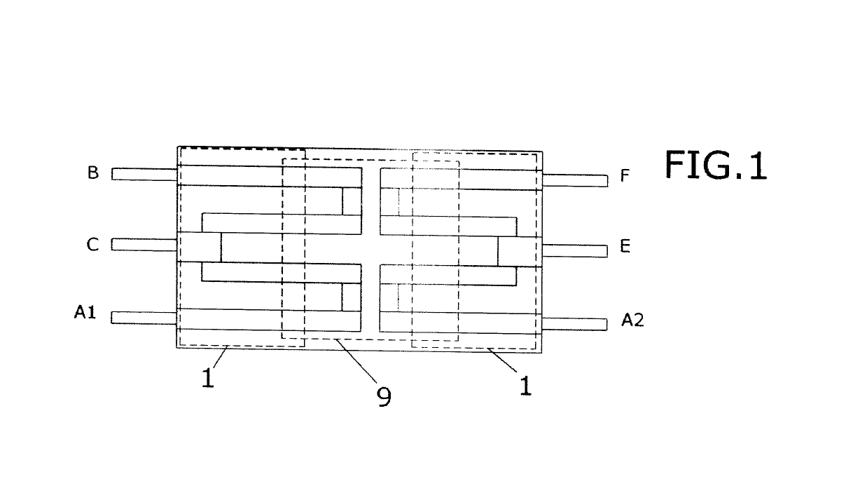

FIG. 1 shows a simplified representation of the interior of a phase shifter, in which there are two fixed circuits (1), and a mobile circuit (9), with the dotted line showing the edges of said circuits. Also observed are the inputs (A1) and (A2) and the outputs (B) (C), (F) and (E).

The displacement of the mobile circuit (9) will make one of the pair of outputs, either the (B) and (C) or the (F) and (E) electrically longer, ie, has a greater phase shift. Thus, if the mobile circuit (9) moves to the left, the outputs (E) and (F) will have more phase shift, and if the mobile circuit (9) is moved to the right it will be the outputs (B) and (C) which have the most phase shift.

The connection between the fixed and mobile lines is carried out by capacitive coupling, and in one possible embodiment the circuits are isolated by a layer of insulating and adhesive material, in principle Teflon due to its good electrical behaviour.

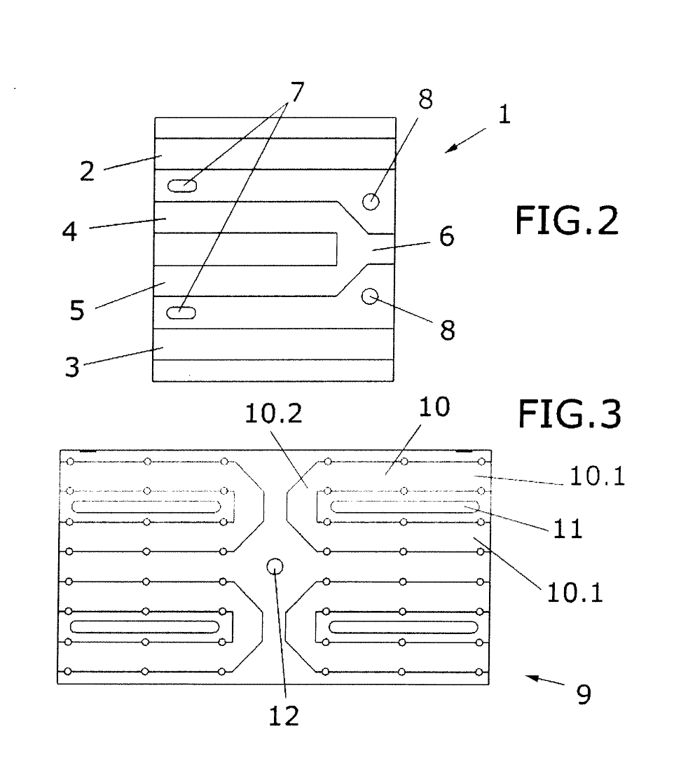

FIG. 2, shows the geometry of each one of the fixed circuits (1), which have an upper branch and a lower branch, the upper branch in turn is composed of two straight line sections (2) and (4) and the lower branch is also composed of two straight line sections (5) and (3), with both arms, the upper and lower joined at one of the ends (6) of the line sections (4) and (5), and the other end of the upper and lower branches are connected by capacitive coupling to the mobile circuit.

In each fixed circuit board (1) a series of perforations (7), (8) have been made for its positioning on the base of the phase shifter, with it possible for the means of attachment to be any other similar system. The perforations (8) are circular, while the perforations (7) are oblong.

FIG. 3 shows the shape of the mobile circuit (9) which has four line sections (10), which have a “U” shape, and grouped in pairs, so that two line sections (10) of the mobile circuit (9) have their free ends in contact with one of the edges of the mobile circuit (9), while the other two line sections (10), are arranged symmetrically to the previous pair, and with the free ends in contact with the facing edge of the mobile circuit (9).

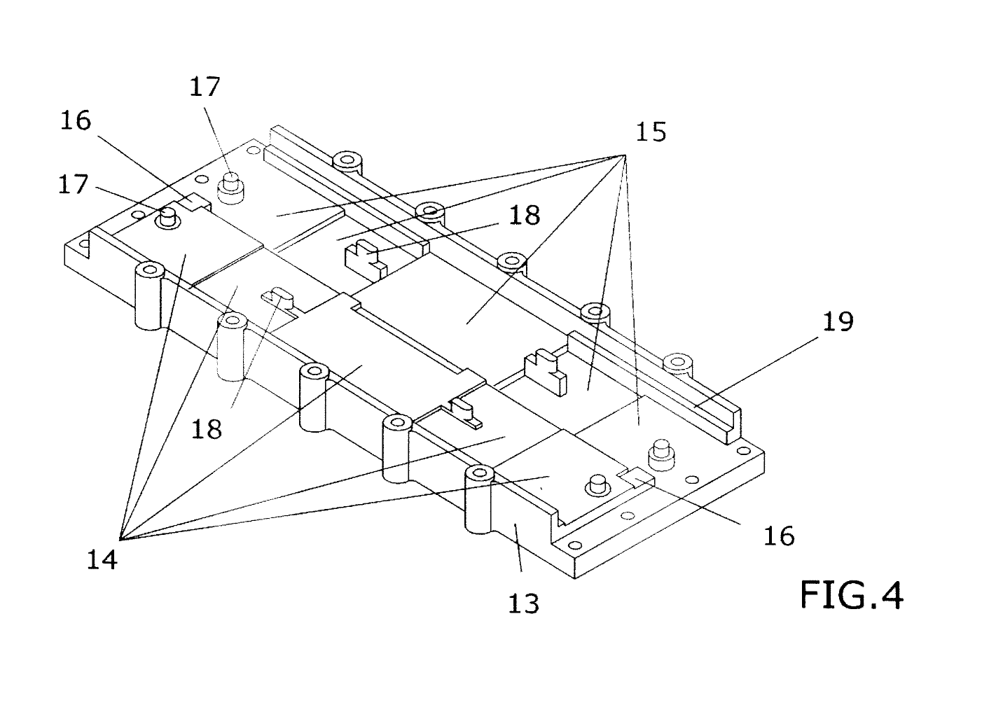

In one possible embodiment, in order to enable linear displacement, the mobile circuit board (9) has a linear oblong opening (11) along which the pins can travel (18) (FIG. 4).

There is also a perforation (12) in the centre of the mobile circuit board (9) which could be used for the coupling of the same through which the linear displacement can be transmitted to the mobile circuit board.

FIG. 4 shows the interior of the base (13) of the phase shifter, in which it is worth noting how it has been achieved that the transmission lines of the fixed circuits have different impedances, varying the distance to the ground plane.

In said FIG. 4, an area (14) can be distinguished, which would have a shorter distance to the lines of the fixed circuits, another area (15) which would have a greater distance to the lines of the fixed circuits (1), and finally an area (16) which would correspond to an intermediate distance of the previous pair and would be in front of the joining area (6) of the two central branches (4) and (5) the fixed circuit.

The fixed circuits (1) would be supported and fixed on the pins (17) and (18), with all of them in a staggered structure, which allows a support to the circuits to be defined, and on the other hand to pass through the perforations (8) and (7) respectively made on the fixed circuit board. Equally on the inside face of the lateral edges of the base (13) of the phase shifter there are some steps (19) which act as supports for the fixed circuits.

The central pins (18) would be those which in addition to providing support and attaching the fixed circuits (1), would act as a guide for mobile circuit (9), passing through the lengthened perforations (11) arranged between each one of the parallel branches of the “U” shaped line sections (10).

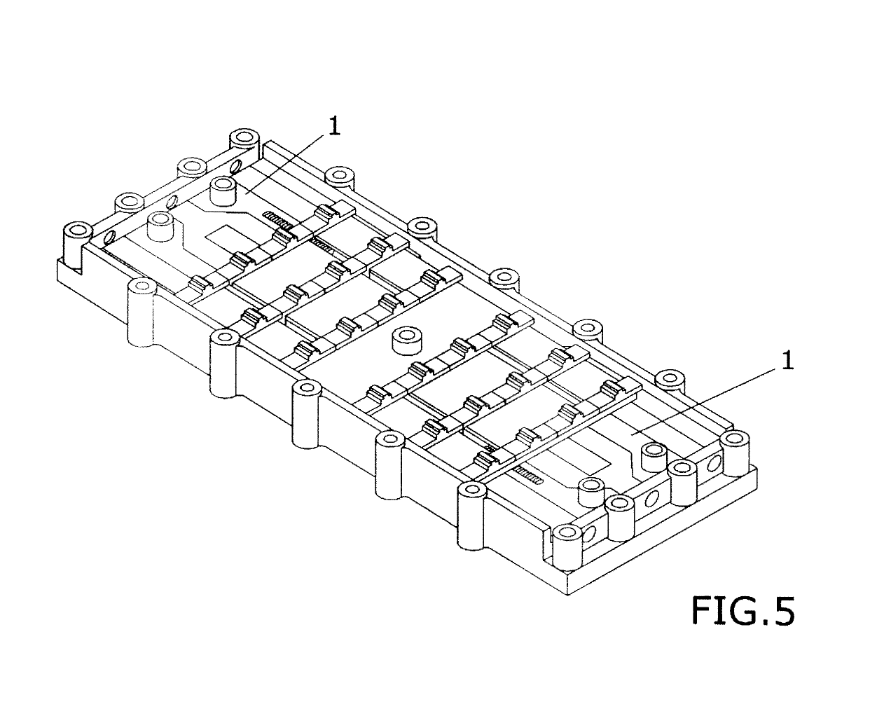

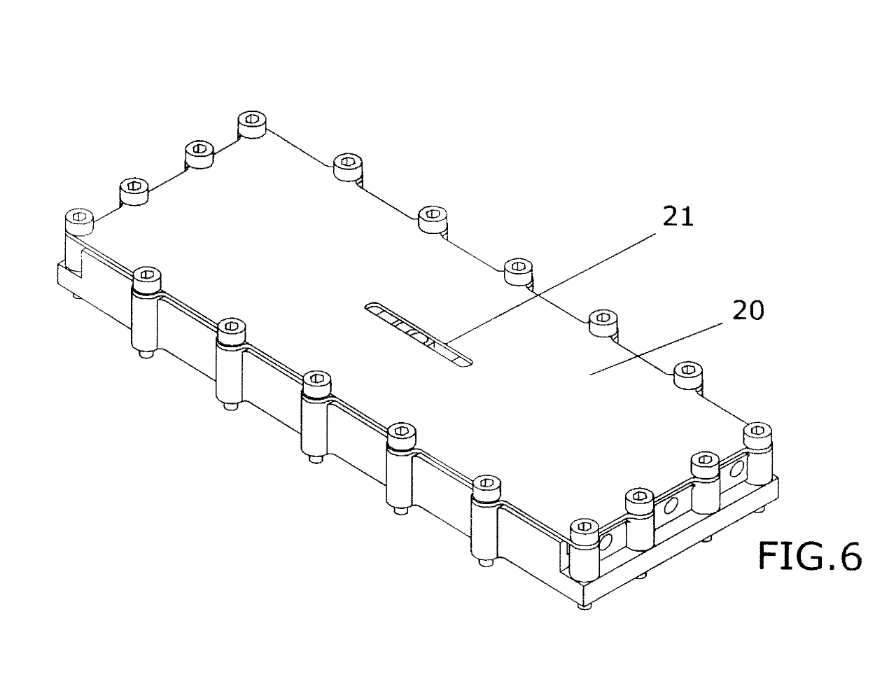

FIG. 5 shows the interior of the phase shifter, having removed the cover plate (20), as shown in FIG. 6, where you can also observe how over the central part of the cover (20) there is a slot (21) from which emerges a connection element with the mobile circuit (9) through which the linear movement is transmitted.

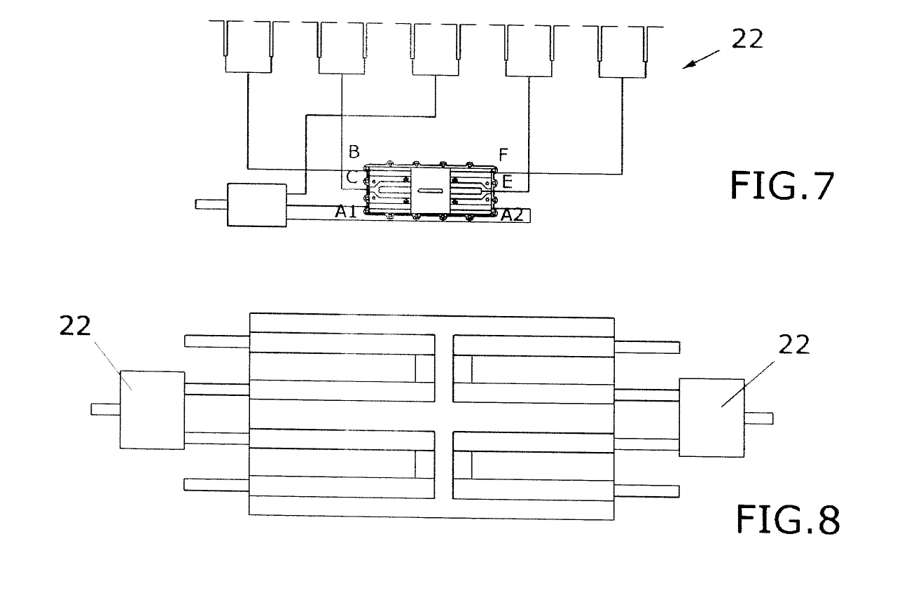

FIG. 7, shows the integration of the phase shifter in an antenna with a variable radiation angle, where it can be observed that said array has 10 radiating elements, where the end elements are connected to the outputs (B) and (F), since the phase shift in these outlets is double, while the outputs (C) and (E) feed the interior elements, providing a gradual phase shift ramp, and by controlling the inclination of the phase ramp through the mechanical position of the phase shifter, it is possible to modify the pointing of the array.

In FIG. 8, and in order to clarify what would happen in the event that the upper and lower phase shift branches were not internally connected and had all the same impedance, it would be necessary to make the connection outside the phase shifter, and also it would be necessary to use impedance transformers (22), which would result in a lower bandwidth that could be covered.

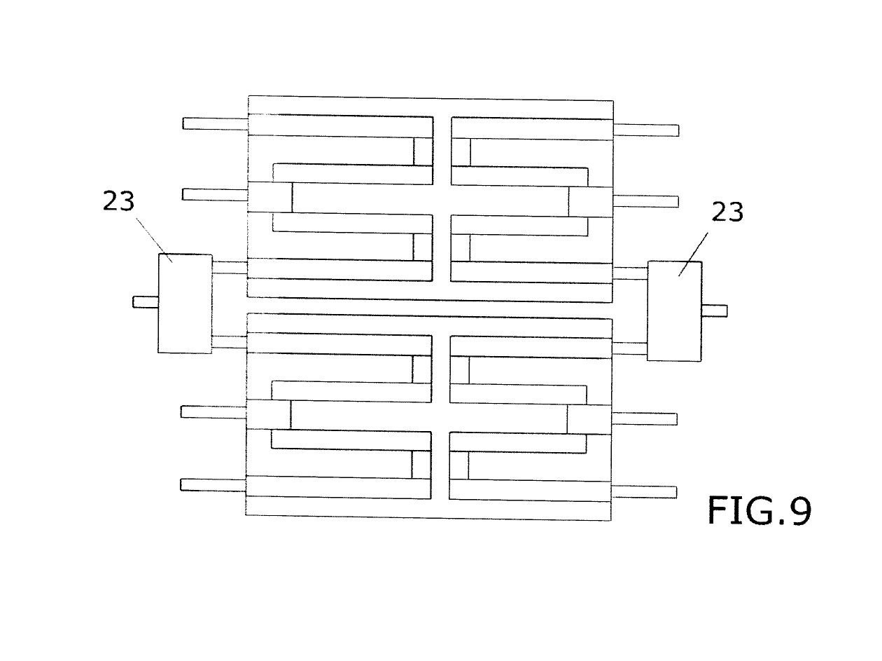

Finally FIG. 9 shows an additional advantage derived from the compact design achieved, given that with an interconnection circuit (23), the passing from four outputs to eight outputs is immediate.

As a result the proposed design achieves a compact design for four outputs and which at the same time is versatile and easily expandable to more outputs, which implies the ability to achieve greater excursion of the radiation angle, and optimized control of lobes, given that with the availability of more outputs it is possible to independently control the elements of the array.

What is claimed is:

1. A linear stripline phase shifter comprising:
a base (13) and a cover (20) that form a closed assembly, having in the interior of the assembly formed by the base (13) and cover (20) two fixed circuits (1) and a mobile circuit (9) which is displaced linearly, where both are formed by sections of stripline lines, where the connection between the line sections of the fixed and mobile circuits is by capacitive coupling, where the distance of the line sections of the fixed circuits to the ground plane formed by the base (13) of the phase shifter is different and characterised in that the phase shifter has outputs (B), (C), (F) and (E) and inputs (A1) and (A2) for adding identical stages of successive phase shifter, which implies the ability to achieve greater excursion of the radiation angle, and optimized control of lobes, given that with the availability of more outputs it is possible to independently control the elements of the array

2. The linear stripline phase shifter according to claim 1, characterised in that the fixed circuits (1) have an upper branch and a lower branch, the upper branch composed of two straight line sections (2) and (4) and the lower branch composed of two straight line sections (5) and (3), with both arms, the upper and lower joined at one of the ends (6) of the line sections (4) and (5), and the other end of the upper and lower branches are connected by capacitive coupling to the mobile circuit, where the line sections have a different distance to the ground plane formed by the base of the phase shifter (13).

3. The linear stripline phase shifter according to claim 2, characterised in that a series of perforations (7), (8) have been made in a board for the fixed circuits for positioning and attachment onto the base (13) of the phase shifter.

4. The linear stripline phase shifter according to claim 3, characterised in that the perforations (8) are circular, while the perforations (7) are oblong.

5. The linear stripline phase shifter according to claim 1, characterised in that the mobile circuit (9) has four line sections (10), which have a “U” shape, and grouped in pairs, so that two of the line sections (10) of the mobile circuit (9) have their free ends in contact with one of the edges of the mobile circuit (9), while the other two line sections (10), are arranged symmetrically to the previous pair, and with the free ends in contact with the facing edge.

6. The linear stripline phase shifter according to claim 5, characterised in that the mobile circuit (9) has a board provided with a linear oblong shaped opening (11) arranged in the interior of each set of line segments (10) in a “U” shape.

7. The linear stripline phase shifter according to claim 5, characterised in that the board of the mobile circuit (9) has a perforation (12) in the centre of the board which is used for coupling through which the linear displacement can be transmitted to the mobile circuit board.

8. The linear stripline phase shifter according to claim 1, characterised in that the circuits are isolated by a layer of insulating and adhesive material.

9. The linear stripline phase shifter according to claim 2, characterised in that the interior of the base (13) of the phase shifter there is an area (14) which has a shorter distance to the lines of the fixed circuits than another area (15) which has a greater distance to the lines of the fixed circuits (1) than the area (14), and finally an area (16) which corresponds to an intermediate distance of the previous pair to the ground plane and would be in front of a joining area (6) of the two line sections (4) and (5) of the fixed circuits

10. The linear stripline phase shifter according to claim 3, characterised in that the fixed circuits (1) are supported and fixed on pins (17) and (18) which are protruding from the base of the phase shifter, with all of them in a staggered structure, which allows a support to the circuits to be defined, and on the other hand to pass through the perforations (8) and (7) respectively made on the fixed circuit board, additionally on the inside face of the lateral edges of the base (13) of the phase shifter there are some steps (19) which act as supports for the fixed circuits.

11. The linear stripline phase shifter according to claim 6, characterised in that the linear stripline phase shifter is provided with central pins (18) passing through the lengthened perforations (11) arranged between each one of the parallel branches of the “U” shaped line sections (10) to provide support and attachment of the fixed circuits (1) and act as a guide for the mobile circuit (9).

12. The linear stripline phase shifter according to claim 1, characterised in that the closing cover (20) has a slot (21) from which emerges a connection element with the mobile circuit (9) through which the linear displacement can be transmitted.
